(19) United States
(12) Patent Application Publication
(10) Pub. No.: US 2002/0111784 A1
(43) Pub. Date: Aug. 15, 2002

(54) Method of suggesting configuration commands based on E-CAD tool output

(76) Inventors: S. Brandon Keller, Fort Collins, CO (US); Gregory Dennis Rogers, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/782,406

(22) Filed: Feb. 12, 2001

(51) Int. Cl. G06F 17/50

(52) U.S. Cl. 703/14

(57) ABSTRACT

A configuration software tool is disclosed for analyzing circuit design violations detected by an E-CAD tool and proposing solutions. An E-CAD tool analyzes a circuit design and outputs violations of design specifications. The configuration tool reads the violations to identify symptoms. The configuration tool accesses a solutions database that stores solutions to common violations encountered with the design. Based on the symptoms, the configuration tool outputs possible solutions for each violation. The user selects one of the proposed solutions or another solution. Based on the selected solution, the configuration tool edits the configuration file of the E-CAD tool. Once all solutions are resolved, the E-CAD tool is re-run on the design. The configuration tool may be stored in a computer system that operates the E-CAD tool, or it may be stored in a remote location accessed by multiple computer systems, such as network server connected to the computer systems.

### FIELD OF INVENTION

The present invention relates generally to computer software. More particularly, it relates to a software method of running an E-CAD tool to simulate circuit performance.

### BACKGROUND

In the field of integrated circuit (IC) design and particularly very large scale integration (VLSI) design, it is desirable to test the design before implementation and to identify potential violations in the design. Before implementation on a chip, the design may be stored in a computer memory. The computer system may store information about specific signals and devices, such as transistors, that are part of the design. In a design, every connection between devices may be labeled as a signal, and every metal layout portion of each signal may be labeled as a segment. The design information may include the connections between devices and the types of conducting segments that link devices and any other properties of these items.

A design may have certain rules or specifications. Software tools, such as electronic computer-aided design (E-CAD) tools, may be used to determine whether a particular design complies with those specifications. Based on the connection and device information, the designer may perform tests on the design to identify potential problems. For example, one portion of the design that might be tested is the conducting material on the chip. Representations of individual metal segments may be analyzed to determine whether they meet certain specifications, such as electro-migration and self-heating specifications. Other examples of testing include electrical rules checking tests, such as tests for noise immunity and maximum driven capacitance, and power analysis tests that estimate power driven by a particular signal and identify those over a given current draw.

The E-CAD tool identifies violations of specifications and alerts the user of particular problems. Violations may be identified and output on a signal-by-signal or segment-by-segment basis. The user then attempts to solve the problems through redesign, or may override or change the specifications for particular violations. For example, the E-CAD tool may perform its initial analysis assuming a worst-case scenario. In some types of analyses, the worst-case scenario may mean the maximum load on a particular layout segment. If the analysis is of the current through a particular segment, then the ECAD tool might assume that all connected devices are driving that segment simultaneously. In fact, this situation might be impossible if, for example, the design does not allow all of the devices to drive the segment at the same time. In this case, the designer may clear the violation by using the E-CAD tool to adjust the design specifications on a segment-by-segment basis.

To analyze a particular circuit, the E-CAD tool uses information about how the circuit performs in various situations. The E-CAD tool more accurately analyzes the circuit if it has more information about how the circuit performs. This information may be input into a configuration file that is read by the E-CAD tool. The configuration file may store, for example, information about which drivers may operate simultaneously.

A configuration file might not initially contain all of the information about a circuit. At the outset, it is impractical to identify every possible specification nuance to input into the configuration file because the design may be very complex and before running the E-CAD tool, the designer may not yet know which problems will likely signal errors. As a result, the E-CAD tool may incorrectly report errors in the design. The user must then consider these reported errors to determine whether they are true errors or whether they are incorrectly-reported errors, in which case the E-CAD tool requires further information about the operation of the design. If they are true errors, the design may require changes. If they are incorrectly-reported errors, the configuration file should be edited to provide the E-CAD tool with further circuit information.

One problem with existing methods of analyzing design errors is that the user may not recognize potential circuit nuances that cause the incorrect reporting of errors. Not every user of the E-CAD tool may understand common errors. For example, numerous individuals may perform E-CAD tool analyses on a circuit design, yet only a handful of designers may be familiar with the intricacies of the design. As a result, few individuals know the design well enough to respond to all or nearly all of the errors reported by the E-CAD tool, while many users may have limited knowledge of some errors. To resolve errors detected by E-CAD tools, an individual not familiar with the nuances of the design must either spend time studying the design, or must discuss the errors with the designers. Both options consume engineering resources that could be better allocated. What is needed is a method for more efficiently analyzing errors reported by an E-CAD tool to determine whether the errors are true design errors, or if the E-CAD tool requires further configuration.

### SUMMARY OF INVENTION

A configuration software tool is disclosed for analyzing circuit design violations detected by an E-CAD tool and proposing solutions. An E-CAD tool analyzes a circuit design stored in a computer memory to detect violations of a specification of the design. The E-CAD tool's configuration file is initially configured to the design. The E-CAD tool outputs violations to a violations file. The configuration tool reads the violations file to identify symptoms of the violations. The configuration tool accesses a solutions database that stores solutions to common violations encountered with the design. As new symptoms and solutions are identified for the circuit, the database may be updated. Based on the symptoms, the configuration tool outputs possible solutions for each violation. The user then selects one of the proposed solutions or another solution. Based on the selected solution, the configuration tool edits the configuration file of the E-CAD tool causing the ECAD tool to better understand the design performance characteristics. Once all solutions are resolved, the E-CAD tool is re-run on the design.

In one implementation, the configuration tool may be a software program stored in a computer system that operates the E-CAD tool. Each user may store the configuration tool on the computer system. In another implementation, the configuration tool, or the solutions database portion of the tool, may be stored in a network location, such as a server. In still another implementation, the configuration tool may incorporated into an E-CAD tool.

### SUMMARY OF DRAWINGS

FIG. 1 shows a block diagram of a computer system that uses the method.

FIG. 2 shows a flow chart of the method.

FIG. 3 shows a block diagram of a network-based system that uses the method.

### DETAILED DESCRIPTION

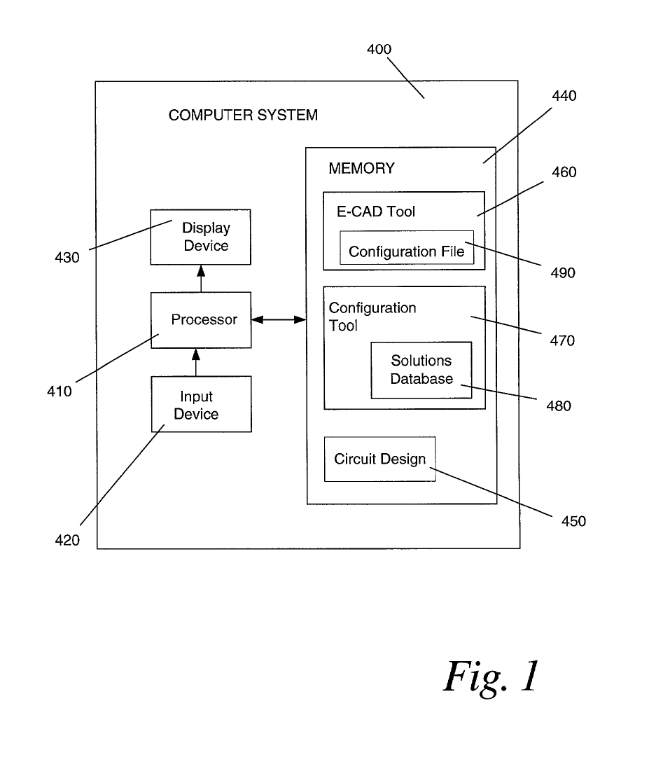

FIG. 1 shows a block diagram of a computer system 400 having a processor 410 connected to an input device 420 and a display device 430. The processor 410 accesses memory 440 in the computer system 400 that stores a VLSI circuit design 450. The design 450 stored in memory 440 includes nodal connection information and information about the physical layout of the design segments. An E-CAD tool 460 and a configuration tool 470 are also stored in the memory 440 for analyzing the circuit model 450. As used herein, “E-CAD tool” refers to any software application for analyzing a circuit design. The E-CAD tool 460 has a configuration file 490 that stores information about the design under test. The configuration tool 470 has a solutions database 480 that stores information about common violations found in the design and their solutions.

The system 400 may be used to analyze errors, also referred to as violations, in the circuit design 450 and to suggest solutions to those violations. In use, the input device 420 receives commands instructing the processor 410 to call the E-CAD tool software 460 to perform a circuit analysis on the model 450. The E-CAD tool 460 is configured to understand certain operations of the design 450. The results of the analysis may be displayed on the display device 430. Lists of violations may be output to the display device 430 and/or may be stored to a violations file in the memory 440. The violations are read by the configuration tool 470 using the processor 410. The configuration tool 470 suggests possible solutions to a user. The configuration tool 470 stores knowledge about the design 450, which can be used to resolve various common violations. The configuration tool 470 outputs potential solutions to the display device 430 in, for example, a dialog box or other visual prompt. The user may select one of the proposed solutions using the input device 420. If no possible solutions are identified or if the user does not wish to implement one of the proposed solutions, then the user may select an alternative solution for resolving the violation using existing methods. The selected solution edits the configuration file 490 of the E-CAD tool 460 so that it better understands the performance of the design 450.

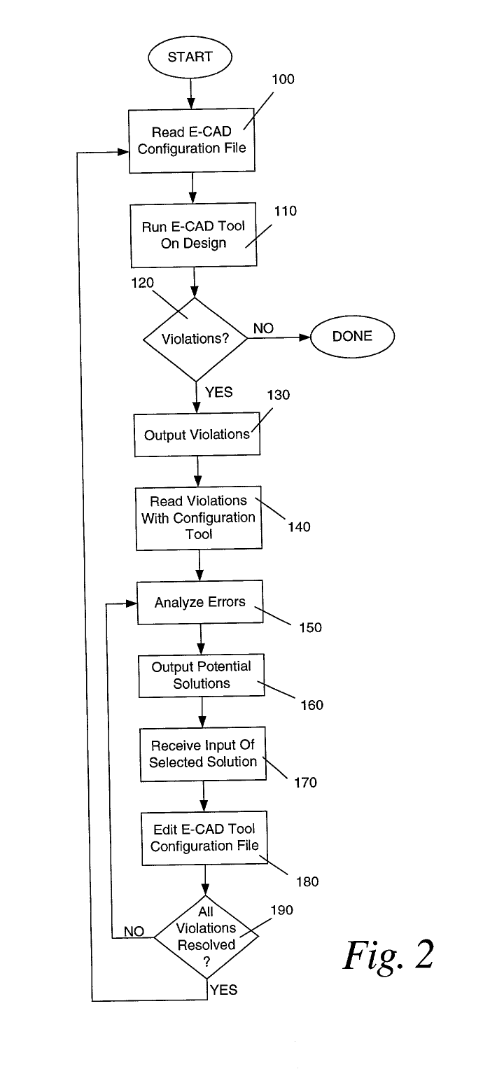

FIG. 2 show a flow chart of the method for resolving circuit design specification violations detected by the E-CAD tool 460. The method may be implemented in, for example, the computer system 400 shown in FIG. 1. The E-CAD tool 460 is configured to a particular circuit design 450 that is analyzed using a configuration file 490. The E-CAD tool 460 reads 100 the configuration file 490 and then runs 110 on the design 450 to detect violations of design specifications. If no violations are detected 120, then the method is complete. If violations are detected 120, the violations are output 130 to a violations file that may be stored in memory 440 and may be displayed on a display device 430. Errors may be detected and reported on a signal-by-signal or segment-by-segment basis. For example, a design 450 may define signals for each connection between circuit elements or devices and may store these signals in the circuit model 450. A design 450 might also store information for each segment of the circuit layout. The E-CAD tool 460 may analyze the design 450 segment-by-segment or signal-by-signal and report violations based on the signals or segments on which the violations are found.

The output of the E-CAD tool 460 is read 140 by the configuration tool 470. The configuration tool 470 accesses a solutions database 480 or data file having a list of common violations and possible solutions to those violations. As used herein, a “solutions database” refers to any data structure containing information about the design that can be used to identify a potential solution to a violation. The solutions database 480 may be created and updated by designers or other users familiar with the details of the design performance. The configuration tool 470 analyzes 150 the violations, cross-references its solutions database 480, and outputs 160 proposed solutions.

For example, the solutions database 480 may contain hundreds or thousands or more circuit characteristics that apply in different situations and may have solutions for these characteristics. The solutions correspond to symptoms common to the design. For example, a particular type of node may regularly trigger a particular type of violation and require a particular solution. A node may regularly report a violation caused by the E-CAD tool's erroneous assumption that all drivers are driving the node simultaneously. In this example, the solution might be to inform the user that nodes of the type reporting the violation often incorrectly assume that all drivers are driving the node, and it may ask the user whether to edit the E-CAD tool configuration file 490 to allow no more than one driver to be active at a given moment. That symptom and solution may be entered into the solutions database 480.

Based on symptoms of the violation, the configuration tool 470 eliminates solutions that do not fit the nodal or other characteristics of the symptoms, leaving a list of possible solutions. In one example, the configuration tool 470 might propose three or four of these possible solutions to the user based upon the circuit characteristics. Along with the possible solutions, the configuration tool 470 also provides a description of the configuration tool's analysis, which can help the user determine whether the proposed solutions make sense in a given situation.

In one embodiment, the proposed solutions may be displayed to a user on the display device 430 using, for example, a dialog box or prompt, and may allow the user to interact with the configuration tool 470 through an input device 420 and a processor 410. The configuration tool 470 then receives 170 the user selection from the input device 420 and edits 180 the configuration file 490 of the E-CAD tool 460 based on that selected solution. This violation resolution process 150, 160, 170, 180 continues until all violations are resolved 190. When all violations are resolved 190, the E-CAD tool reads 100 the edited configuration file 490 and analyzes 110 the circuit 450 again.

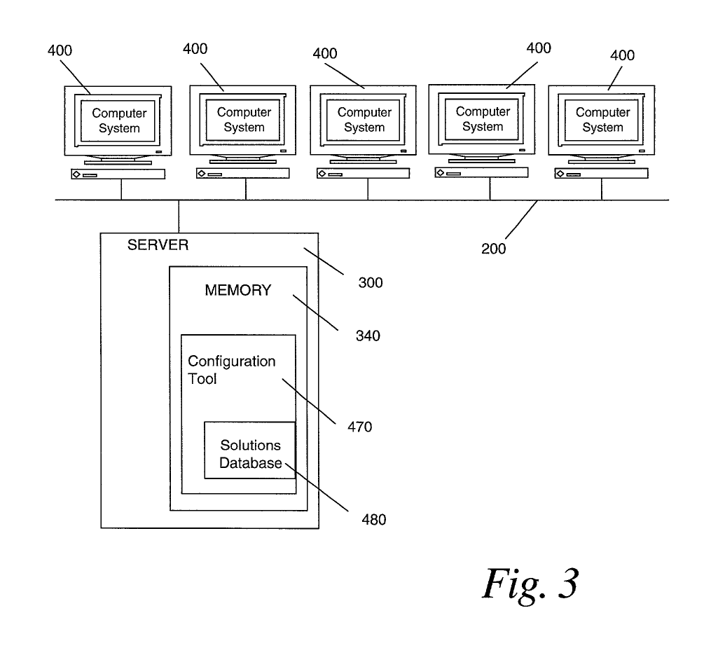

FIG. 3 shows a network-based embodiment of a system for implementing the method. Multiple computer systems or terminals 400 are connected to a local or global network 200, such as the Internet or an intranet. A server 300 having a memory 340 is also connected to the network 200. Computer systems 400 access applications and data stored in the memory 340 of the server 300. In this embodiment, the configuration tool 470 and/or the solutions database 480 reside in a network-based computer-readable medium 340, such as the hard disk 340 of a network server 300. Users operating the E-CAD tool 460 may use computer systems 400 also connected to the network 200, such that multiple users may access the configuration tool 470 and/or the solutions database 480 simultaneously. This also allows an individual, such as a network administrator, to more easily update the solutions database 480 as new solutions and symptoms become known.

In one embodiment, both the configuration tool 470 and the solutions database 480 may be stored on the server 300. In another embodiment, the solutions database 480 may be stored separately from the configuration tool 470. Part or all of the configuration tool application 470 may be stored locally to one or more computer systems 400 or may be stored in another network or remote location. In still another embodiment, the configuration tool 470 may be part of the same application as the E-CAD tool 460, such as an improved E-CAD tool 460. The solutions database 490 may be part of the tool or it may be located in a remote location, such as a network location on a server 300 accessed by multiple users.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

We claim:

1. A method for analyzing a circuit design comprising:
reading violations of a specification for a circuit design;
identifying symptoms of the violations based on the circuit design;
identifying solutions to the violations based on the symptoms, using data in a solutions database; and
proposing a proposed solution based on data stored in the solutions database.

2. The method of claim 1, further comprising:
running an E-CAD tool on the circuit design; and
detecting violations of the specification using the E-CAD tool.

3. The method of claim 2, further comprising storing the violations to a violations file, and wherein the step of reading violations comprises reading the violations file.

4. The method of claim 2, further comprising configuring the E-CAD tool to the circuit design using a configuration file.

5. The method of claim 1, further comprising:
receiving a selected solution;
re-configuring an E-CAD tool based on the selected solution; and
re-running the E-CAD tool on the circuit design.

6. The method of claim 5, wherein the step of proposing the proposed solution comprises displaying at least one proposed solution on a display device, and wherein the step of receiving the selected solution comprises receiving an input signal from an input device.

7. The method of claim 5, wherein the step of re-configuring comprises editing a configuration file of the E-CAD tool.

8. The method of claim 1, further comprising storing data related to symptoms and solutions for the circuit configuration in the solutions database.

9. The method of claim 1, wherein the steps of reading violations, identifying symptoms, identifying solutions, and proposing the proposed solution comprise using a software configuration tool stored in a computer memory.

10. A computer system for analyzing signals in a circuit design stored in a memory, the system comprising:
a storage medium; and
a processor for executing a software program stored on the storage medium for analyzing a circuit design, the software comprising a set of instructions for:
reading violations of a specification for a circuit design;
identifying symptoms of the violations based on the circuit design;
identifying solutions to the violations based on the symptoms, using data in a solutions database; and
proposing a proposed solution based on data stored in the solutions database.

11. The system of claim 10, further comprising instructions for:
configuring an E-CAD tool to the circuit design using a configuration file;
running the E-CAD tool on the circuit design;
detecting violations of the specification using the E-CAD tool; and
storing the violations to a violations file; and
wherein the step of reading violations comprises reading the violations file.

12. The system of claim 11, further comprising instructions for:
receiving a selected solution;
re-configuring the E-CAD tool based on the selected solution; and
re-running the E-CAD tool on the circuit design.

13. The system of claim 10, further comprising instructions for:
receiving a selected solution; and
editing a configuration file of an E-CAD tool based on the selected solution.

14. The system of claim 13, wherein the step of proposing the proposed solution comprises displaying at least one proposed solution on a display device, and wherein the step of receiving a selected solution comprises receiving an input signal from an input device.

15. A computer-readable medium having computer-executable instructions for performing a method for analyzing a computer representation of a circuit design, the method comprising:
reading violations of a specification for a circuit design;
identifying symptoms of the violations based on the circuit design;
identifying solutions to the violations based on the symptoms, using data in a solutions database; and
proposing a proposed solution based on data stored in the solutions database.

16. The medium of claim 15, the method further comprising:
configuring an E-CAD tool to the circuit design using a configuration file;
running the E-CAD tool on the circuit design;
detecting violations of the specification using the E-CAD tool; and
storing the violations to a violations file; and
wherein the step of reading violations comprises reading the violations file.

17. The medium of claim 16, the method further comprising:
receiving a selected solution;
re-configuring the E-CAD tool based on the selected solution; and
re-running the E-CAD tool on the circuit design.

18. The medium of claim 15, the method further comprising:
receiving a selected solution; and
editing a configuration file of an E-CAD tool based on the selected solution.

19. The medium of claim 18, wherein the step of proposing the proposed solution comprises displaying at least one proposed solution on a display device, and wherein the step of receiving a selected solution comprises receiving an input signal from an input device.

20. The medium of claim 18, the method further comprising re-running the E-CAD tool on the circuit design.
